(19) United States
(12) Patent Application Publication
(10) Pub. No.: US 2026/0364854 A1
(43) Pub. Date: Nov. 19, 2026

(54) METHOD AND DEVICE FOR PROCESSING POLYMER MATERIALS

(71) Applicant: EREMA Engineering Recycling Maschinen und Anlagen Gesellschaft m.b.H., Ansfelden (AT)

(72) Inventors: Klaus FEICHTINGER, Linz (AT); Roland HUBER, St. Pantaleon (AT)

(73) Assignee: EREMA Engineering Recycling Maschinen und Anlagen Gesellschaft m.b.H., Ansfelden (AT)

(21) Appl. No.: 19/136,696

(22) PCT Filed: Dec. 7, 2023
(86) PCT No.: PCT/AT2023/060432

§ 371 Date: Jun. 6, 2025

(30) Foreign Application Priority Data
Dec. 7, 2022 (AT) A50930/2022

(51) Int. Cl. B29B 17/00; B29B 17/04; B29C 48/40

(52) U.S. Cl. CPC B29B 17/0026; B29B 17/0412; B29C 48/40; B29B 2017/048

(57) ABSTRACT

The invention relates to a method and a device for processing or treating polymer materials, in particular thermoplastic waste plastic for recycling purposes, wherein, in a container or cutter-compactor (1), the polymer materials to be processed are, by means of at least one rotatable or rotating tool (3a, 3b), optionally a plurality of rotatable or rotating tools (3a, 3b), moved, mixed, heated and optionally comminuted, and wherein the polymer materials, which are in the form of pieces or particles, are subsequently discharged from the container (1) and introduced into a conveyor (6), in particular an extruder (6), preferably a twin-screw or multiple-screw extruder, in particular in order to be compacted and melted or agglomerated therein. According to the invention, the torque of the conveyor (6) is measured and the rotational speed of the tool or of at least one of the tools (3a, 3b) is controlled or changed according to the torque of the conveyor (6).

The invention relates to a method and a device for processing or treating polymer materials, in particular thermoplastic waste plastic for recycling purposes, according to the preambles of claim 1 and claim 16, respectively.

Methods and devices that use a combination of a container or a preconditioning unit (PCU) and a conveyor connected thereto, in particular an extruder, for treating polymer waste, in particular different thermoplastics, are sufficiently known.

In this case, devices are often arranged upstream of an extrusion system for pretreating the materials to be processed, for example known cutter-compactors or preconditioning units (PCUs), which are typically containers with rotary tools, and which containers are directly coupled to an extruder. This treating step in the PCU upstream of the extrusion process also includes the task of changing the shape and properties of the polymer materials accordingly. In doing so, it is purposeful to introduce energy into the material. The thermoplastic materials are without limitation mixed, heated, softened, compacted, pre-degassed, dried, dehumidified, cut, compacted, pre-degassed, dried, dehumidified, cut, comminuted, crystallized, and/or homogenized in the pre-treatment unit, and their bulk density is increased.

The previously treated polymers are then introduced into an extruder to be compacted, in particular melted. Such combination devices have long been known, for example from EP 2 558 263 or EP 2 689 908.

The mixing and grinding tools rotating in the container or the PCU also support the filling or feeding process of the conveyor or extruder connected to the container. The conveying process and the extrusion process are both usually particularly efficient when the fill level of the screw is constant and sufficiently high. The infeed area of the conveyor or extruder is therefore sensitive and has a significant influence on the final result to be achieved or the quality of the recycled materials. In this context, for example, the distance of the mixing and grinding tools to the conveyor or extruder screw, the shape and size of the infeed opening, the direction of rotation of the mixing tools relative to the conveying direction of the conveyor or extruder play a certain role, but also on the side of the conveyor or extruder, among other things, the profile of the screw web, the shape of the screw base or the free open surface of the screw channel.

An unfavorable infeed behavior of the conveyor or extruder can for example result in a pumping action of the volumetric throughput, i.e. a change in the throughput over time, which is disadvantageous for reliable operation and for the quality of the recycled materials.

The prior art has therefore seen no lack of attempts to adjust the sensitive area of the infeed or feed zone of a conveyor or extruder or to design it such that the feeding behavior and the feed zone of the screw are supported as best as possible and, for example, also become more tolerant to material variability induced by operating conditions.

Twin-screw or multi-shaft extruders are then also used in addition to single screw extruders, in particular to achieve special material grades and also to compound these materials. These extruder systems are also directly coupled to the PCU. In this case, the lower-most tool plane of the container, which can preferably consist of a disc on which tools can be mounted and is located in the area of the extruder opening, introduces the pretreated materials into the extrusion device.

The number of packing cycles of the tools of the lower-most tool plane in the area of the conveyor opening or extruder opening generally has a special influence on the fill level of the conveyor or extruder. Furthermore, the mean bulk density of the materials in the PCU, in particular in the lower-most area of the PCU, is also responsible for the fill level according to the mean compaction. It is relatively irrelevant whether the conveyor or extruder is filled from the side or in the area of the gusset of the twin screw, or with which direction of rotation of the tools the conveyor or extruder opening is filled.

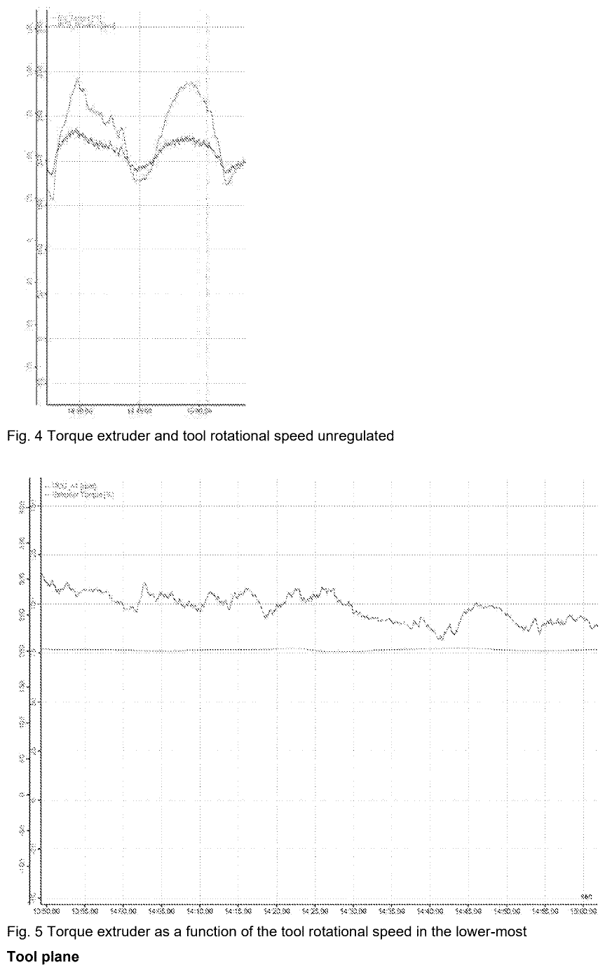

The material fed into the conveyor or extruder is immediately transported further and there is a torque graph of the drive of the conveyor or extruder as a function of the fill level. In principle, one endeavors to keep the torque graph of the conveyor or extruder or the fill level of the conveyor or extruder as constant as possible. This results in a qualitatively good melting of the polymers without the occurrence of shear peaks, which can lead to an overtemperature of the polymer melt. An excessively low infeed rate of the conveyor or extruder, i.e. an excessively low fill level, can lead to loss of throughput and shear peaks, but can also result in poorly homogenized polymers. Accordingly, it is advantageous for the quality of the recycled materials and economic efficiency to keep the fill level of the conveyor or extruder constant. FIG. 4 shows an example of an unfavorable torque change of the extruder as a function of the rotational speed of the tool. Here, for example, the rotational speed of the tool was varied to try and meet the needs of the incoming material with respect to moisture, compaction, and material temperature in the PCU, resulting in fluctuations of extruder torque and rotational speed of the tools with significant negative impact for feeding behavior and material quality.

Merely mixing the materials in the PCU already has a certain (minor) damping effect on any bulk density variation of the input materials. However, mixing alone and often also intensive pretreatment of the materials in the PCU is not sufficient in some cases, and it is not possible to keep the bulk density sufficiently constant over a longer period of time in all cases. Rather, the bulk density of the treated materials fluctuates up and down over time from a mean value. This is already disadvantageous and causes the described disadvantages.

It is thus the object of the present invention to provide a method or device of the aforementioned type with which the fill level of the conveyor or the extruder can be kept as constant as possible.

This object is solved according to the method by the characterizing features of claim 1. Accordingly, a method is provided for processing or treating polymer materials, in particular thermoplastic waste plastic for recycling purposes, wherein the polymer materials to be processed in a container or cutter-compactor or a preconditioning unit (PCU) by at least one rotatable or rotating tool, optionally, a plurality of rotatable or rotating tools, moved, mixed, heated and optionally comminuted, and wherein the polymer materials, which are in the form of pieces or particles, are subsequently discharged from the container and introduced into a conveyor or extruder, in particular in order to be further compacted and melted or agglomerated therein.

According to the invention, the torque of the conveyor or extruder is measured, and the rotational speed of the tool or at least one of the tools is controlled or changed as a function of the measured torque of the conveyor or extruder.

This object is solved according to the device analogously to the characterizing features of claim 16. Accordingly, a device is provided for processing or treating polymer materials, in particular thermoplastic waste plastic for recycling purposes that is particularly suited for carrying out the above method, which device has at least one container or cutter-compactor or a preconditioning unit (PCU) for the material to be processed, wherein at least one tool rotating or rotatable about an axis of rotation, optionally, a plurality of rotating or rotatable tools, is or are arranged in the container for moving, mixing, heating and optionally comminuting the material, wherein a container opening is formed in the container through which the pretreated material can be discharged from the interior of the container. The container opening is in particular formed in a side wall of the container, in particular in the area, or at the height, of the tool in the lower-most position or closest to the floor. Furthermore, at least one conveyor or an extruder is provided for accepting the material discharged from the container through the container opening.

The invention provides that a measuring device for measuring the torque of the conveyor or extruder is provided, that a control device—having a communication link or data link to the measurement device—for controlling the rotational speed of the tool or at least one of the tools is provided, wherein the control device is adapted and/or arranged to control the rotational speed of the tool as a function of the torque of the conveyor or extruder. The control device therefore controls the rotational speed of the tool as a function of the torque of the conveyor or extruder measured by the measuring device.

The invention thus proposes to directly influence, control or change the rotational speed at which the tools rotate in the PCU or in the container based on the torque of the conveyor or extruder. Due to the rotational speeds of the tools adjusted in this manner, the packing cycles into the conveyor system or extruder system are directly influenced, and the torque of the conveyor or extruder subsequently in turn changes according to the fill level of the screw channels of the conveyor or extruder. The fill level of the conveyor or extruder can as a result be kept constant. The feeding behavior of the screw is improved and the throughput as well as the throughput consistency is also improved. This makes the total system of cutter-compactor and conveyor or extruder more stable and efficient. Furthermore, the quality of the polymer materials obtained can be increased and the economic operating efficiency can be increased. In principle, the effects mentioned are relevant and present in all conveyors or extruders, i.e. not only for compacting screws for extruders or agglomerators, but also for non-compacting or less compacting screws with predominant or pure conveying function.

In the present case, the general term “conveyor” is understood to refer to systems with non-compacting or decompacting screws as well as systems with compacting screws, i.e. with extruder screws with an agglomerating or plasticizing effect.

In this text, the terms “extruder” or “extruder screw” describe conveyors or screw conveyors by which the material is completely or partially melted, i.e. classic extruders, but also conveyors or screw conveyors that only agglomerate but do not melt the softened material. Such agglomerating screws only briefly heavily compact and shear, but do not plasticize, the material. The agglomerating screw therefore supplies material at its outlet, which material has not been completely melted, but consists of only superficially molten particles that are baked together in the same way as a sintering operation. In both cases, however, the screw exerts pressure on the material during the conveying and compacts the latter.

Systems for measuring the torque of conveyors or extruders are known. For example, in extruders, a torque sensing unit can be arranged in the connection region between the transmission output shaft and the extruder shaft for contactless sensing of torque transferable to the extruder shaft by the transmission output shaft and the connection region. Other systems for continuous monitoring of the torque of conveyors or extruders are also known; for example torque sensors according to the principle of magnetostriction. Such systems are primarily used to detect and rule out possible overload situations in order to be able to operate the extruder, for example, closer to the load limits, in order to increase the drive power or the torque density.

The torque of the conveyor or extruder is advantageously measured continuously at defined, in particular regular, intervals. An advantageous device is accordingly characterized in that the measuring device is adapted and arranged to continuously measure the torque of the conveyor or extruder at defined, in particular regular, intervals.

This means that the torque is measured for the duration of the method, either at predefined times or at defined time intervals, and the data is transmitted to the control device in order to be able to react to changes and to adjust the rotational speed of the tools, quickly and continuously.

Advantageously, the conveyor or the extruder is operated at a fixed rotational speed. An advantageous device is characterized accordingly in that the control device is adapted and arranged to operate the conveyor or extruder at a fixed rotational speed.

If the conveyor or extruder runs at a fixed rotational speed nEx=const [rpm], different packing cycles per rotation nEx result at variable rotational speed of the tools nW [rpm]. Thus, the fill level of the screw channels and subsequently the torque of the conveyor or extruder MEx [Nm] changes.

The rotational speed of the tool is advantageously reduced as the torque of the conveyor or extruder increases, or the rotational speed of the tool is increased as the torque of the conveyor or extruder decreases. An advantageous device is characterized accordingly in that the control device is adapted and arranged to reduce the rotational speed of the tool as the torque of the conveyor or extruder increases and/or to increase the rotational speed of the tool as the torque of the conveyor or extruder decreases.

The rotational speed of the tools nWE [rpm] in the PCU is defined as a function of the torque of the conveyor or extruder MEx [Nm]. Accordingly, if the rotational speed of the tools is reduced as the torque of the conveyor or extruder increases, this leads to reduced packing cycles and thus to a lower fill level of the conveyor or extruder or the screw channels of the conveyor or extruder. This in turn leads to a decrease in the torque of the conveyor or extruder. This can be mapped accordingly by a PID controller.

Advantageously, the rotational speed of the tool is controlled such that the torque of the conveyor or extruder remains constant or the fluctuations of the torque are less than +/−5%, preferably less than +/−3%. An advantageous device is accordingly characterized in that the control device is adapted to adjust the rotational speed of the tool such that the torque of the conveyor or extruder remains constant or can be held or the fluctuations of the torque are less than +/−5%, preferably less than +/−3%.

In this way, it can be achieved that the torque profile of the conveyor or extruder is kept as constant as possible and that peaks or major changes are avoided.

The rotational speed of the tool is advantageously controlled such that the fill level of the conveyor or extruder remains constant or the fluctuations of the fill level are low/less than +/−10%, preferably less than +/−5%. An advantageous device is characterized accordingly in that the control device is adapted to adjust the rotational speed of the tool such that the fill level of the conveyor or extruder remains constant or can be held or the fluctuations of the fill level are low/less than +/−10%, preferably less than +/−5%.

As mentioned above, it is also sensible with regard to the quality of the end product and economic efficiency to keep the fill level of the conveyor or extruder or the screw(s) of the conveyor or extruder, e.g. defined in kg/revolution, as constant as possible. The fill level of the conveyor or extruder can be determined or calculated by practical means or can be carried out, for example, via a pressure measurement in the screw or via ultrasonic measurement, as described, for example, in AT 505618 E1.

In some cases, however, the material treating or preparation follows different rules than the loading of the conveyor or extruder. For example, different parameters in the input material, e.g. highly variable humidity, may require keeping the rotational speed of the tools relatively high in order to introduce sufficient energy into the material during a predetermined setup of the tools, e.g. in order to maintain the evaporation of the moisture and to achieve compaction. This may limit the degree of freedom of the rotational speed of the tools.

Advantageously, the rotational speed of the tool is controlled such that the rotational speed of the tool does not fall below a certain minimum rotational speed. An advantageous device is accordingly characterized in that the control device is adapted to adjust the rotational speed of the tool such that the rotational speed of the tool does not fall below a certain minimum rotational speed.

This ensures that the torque of the conveyor or extruder is kept as constant as possible, but at the same time sufficient energy can always be introduced into the material to be processed.

In order to compensate for different parameters in the input material and to ensure good processing, it can be advantageous if the rotational speed of the tool can also be adjusted, in particular increased, independently of the torque of the conveyor or extruder. An advantageous device is accordingly characterized in that the rotational speed of the tool can additionally also be adjusted, in particular increased, independently of the torque of the conveyor or extruder. This allows greater processing flexibility, and, for example, differences in the materials to be processed can be responded to. Above all, with certain requirements, the rotational speed of the tools must be higher and cannot be reduced since too little energy would otherwise be introduced into the material.

The tools are advantageously arranged in the container in at least two tool planes arranged one above the other. An advantageous device is accordingly characterized in that a plurality of, at least two, tools are arranged in the container in different tool planes or at different distances to the bottom surface or lower-most region of the container and in that the tools are arranged in the container in at least two tool planes arranged one above the other. Often, the material to be processed is fed into the top of the container, passes through the container from top to bottom in a certain dwell time, while being heated, softened, and mixed, and is then discharged along the bottom into the conveyor or extruder. Tools at different heights or distances to the floor facilitate advantageous treatment and increase flexibility.

The lower-most tool plane is advantageously arranged in the area or at the height of the feed opening of the conveyor or extruder. An advantageous device is accordingly characterized in that the lower-most tool plane is arranged in the area or at the height of the container opening or the feed opening of the conveyor or extruder connected to the container opening.

This ensures effective filling of the conveyor or extruder.

The tools in the individual tool planes can advantageously be rotated independently of each other and at different rotational speeds, in particular by separate drives. An advantageous device is accordingly characterized in that the tools in the individual tool planes can be rotated independently of each other and at different rotational speeds, in particular by separate drives. This also increases processing flexibility. For this purpose, two or more different drives can be used, which can be influenced accordingly in their rotational speed. It is possible to drive the tools from above, from below or from the circumference.

Advantageously, the rotational speed of the tool in the lower-most tool plane is controlled as a function of the torque of the conveyor or extruder. An advantageous device is accordingly characterized in that the rotational speed of the tool in the lower-most tool plane can be controlled by the control device as a function of the torque of the conveyor or extruder.

In this way, in any case, the rotational speed of the tools of the lower-most tool plane, i.e. in the area of the filling opening of the conveyor or extruder, is controlled as a function of the torque of the conveyor or extruder. The rotational speed of the tools of the other higher tool plane can, but do not have to, be controlled as a function of the torque of the conveyor or extruder, i.e. these tools can also rotate at a defined or adjustable rotational speed that does not depend on the torque of the conveyor or extruder or is not torque-controlled by the control device.

In this way, for example, the polymer material in the upper region of the container can be processed at higher rotational speeds and correspondingly higher energy input, i.e. at higher temperatures. In the lower area of the PCU, the rotational speed of the tools is then adjusted accordingly to keep the torque of the conveyor or extruder or the fill level constant. Thus, a degree of freedom or decoupling of the material preparation in the container from the loading of the conveyor or extruder is achieved.

It can also advantageously be provided that the rotational speed of the tool is only controlled in the lower-most tool plane as a function of the torque of the conveyor or extruder and the rotational speed of the tool or tools in the other tool plane(s) above these is controlled or adjusted independently of the torque of the conveyor or extruder. An advantageous device is accordingly characterized in that the rotational speed of the tool can only be controlled in the lower-most tool plane by the control device as a function of the torque of the conveyor or extruder and in that the rotational speed of the tool or tools in the other tool plane(s) above these is controlled or adjustable independently of the torque of the conveyor or extruder.

Here, it is therefore not optionally, but mandatorily provided that the rotational speed of the tools of the other higher tool planes is not controlled as a function of the torque of the conveyor or extruder, but rather differently.

It can advantageously also be provided that the rotational speeds of all tools in each tool plane are controlled as a function of the torque of the conveyor or extruder, independently and separately from one another. An advantageous device is accordingly characterized in that the rotational speeds of all tools in each tool plane can be controlled by the control device, in each case as a function of the torque of the conveyor or extruder, independently and separately from one another.

Accordingly, the rotational speeds of all tools in all tool planes are torque-controlled but are each adjustable independently of each other or individually.

It can advantageously also be provided that the rotational speed of the tool or tools in the other tool plane(s) above these is controlled such that a certain material temperature is reached in this area. It is also advantageous if the temperature of the material is measured in this range and the rotational speed of the tool or tools in the other tool plane(s) above these is controlled or changed as a function of this material temperature. An advantageous device is accordingly characterized in that the rotational speed of the tool(s) in the other tool plane(s) above these is controlled such that a certain material temperature is reached in this area and/or that the rotational speed of the tool(s) in the other tool plane(s) above these can be controlled or changed as a function of this material temperature.

The tools are advantageously discs, rods or bars, in particular with knives arranged on them.

If tools are arranged in a plurality of tool planes, in particular a plurality of discs, they can, but do not have to, be of the same size, thus can also have different dimensions or diameters in relation to each other.

An advantageous device is characterized in that the conveyor comprises at least one compaction screw and is adapted as a single screw extruder. Furthermore, conveyors with a plurality of compaction screws are particularly advantageous. It is particularly advantageous if the conveyor is a twin-screw extruder, in particular a synchronous twin-screw extruder. The effects for achieving a good fill level in practice are particularly advantageous in twin screw extruders or multi screw extruders. Particularly on synchronous, combing two- or multi-shaft extruders—regardless of whether the screws have a parallel path or a conical path especially in the infeed area—the number of packing cycles of the lower-most tool plane in the area of the extruder opening has a special influence on the fill level of the extruder system and results in a torque graph of the extruder drive as a function of the fill level.

For the feeding behavior, it is also advantageous, among other things, how the tools of the cutter-compactor introduce the previously treated material into the feed opening of the conveyor or extruder or support this process. This depends, among other things, on the direction of rotation of the screw and the direction of rotation of the tools. In this context, it has proven advantageous if the direction of rotation of the tool of the lower-most plane is substantially opposite or opposite to the direction of conveying of the conveyor or extruder in the area in front of the container opening or in the area in front of the feed opening or infeed opening of the conveyor or extruder. Such arrangements are generally already known, for example from EP 2 558 263 B1 or EP 2 689 908 B1, and are included in the present disclosure by reference.

It is particularly advantageous if the longitudinal axis of the conveyor or the screw or the longitudinal axis of the screw closest to the feed opening or the inner wall of the housing or the screw envelope extends tangentially to the inner side of the side wall of the container, wherein the screw is preferably on its front face connected to a drive and on its opposite front face conveys toward an outlet opening, in particular an extruder head, arranged on the front face of the housing.

It is further advantageous if it is provided that the opening in the PCU is connected to the feed opening immediately and directly and without long spacing or transition distance, e.g. to a screw conveyor. This allows for an effective and gentle material transfer.

An advantageous device is further characterized in that the container is cylindrical or conical. However, the container does not necessarily have to have a circular-cylindrical shape, although this shape is advantageous for practical and technical manufacturing reasons. Container shapes deviating from the circular-cylindrical shape, such as frustoconical containers or cylindrical containers with an elliptical or oval footprint, can be converted to a circular-cylindrical container of the same volume, assuming that the height of this fictitious container is equal to its diameter. Container heights that significantly exceed the self-generating mixing vortex (taking into account the safety distance) are not taken into account, since this excessive vessel height is not used and therefore no longer affects the material processing.

An advantageous device is characterized in that the conveyor or extruder is connected tangentially to the container and/or in that the housing of the conveyor or extruder comprises an infeed opening on its front face or in its jacket wall for the material to be collected by the screw or screws of the conveyor or extruder, and in that the infeed opening is connected to the container opening.

A further advantageous embodiment provides that the collection container is substantially cylindrical with a planar bottom surface and a cylinder-shaped jacket side wall aligned vertically thereto. A simple design further specifies that the axis of rotation of the tool or tools coincides with the central center axis of the collection container. A further advantageous embodiment provides that the axis of rotation of the tool or tools or the central center axis of the container are aligned vertically and/or normal to the bottom surface. This also applies analogously to conical containers. These special geometries optimize the infeed behavior in a structurally stable device with a simple design.

In this context, it is also advantageous to provide that the tool—or the lower-most tool closest to the floor if a plurality of tools are arranged one above the other—as well as the opening are arranged at a small distance from the bottom surface, in particular in the region of the lower-most quarter of the height of the collection container. The distance is defined and measured from the lower-most edge of the opening or the infeed opening to the bottom of the container in the edge region of the container. Since the corner edge is typically rounded, the distance from the lower-most edge of the opening is measured along the imaginary extensions of the side wall downwards to the imaginary extension of the container bottom outwards. Suitable distances are 10 to 400 mm.

Furthermore, it is advantageous for processing if the radially outermost edges of the tool reach close to the side wall of the container.

A device with a cutter-compactor or a preconditioning unit (PCU) with at least one rotatable or rotating mixing or comminuting tool and with a container opening formed in the side wall of the cutter-compactor in the area of the height of the lower-most tool closest to the floor is particularly advantageous.

A twin-screw extruder is connected tangentially to this container opening, into which the pretreated material is introduced.

Further advantages and embodiments of the invention result from the description and the enclosed drawings. The invention is shown schematically in the drawings by means of non-limiting exemplary embodiments and is described below by way of example with reference to the drawings.

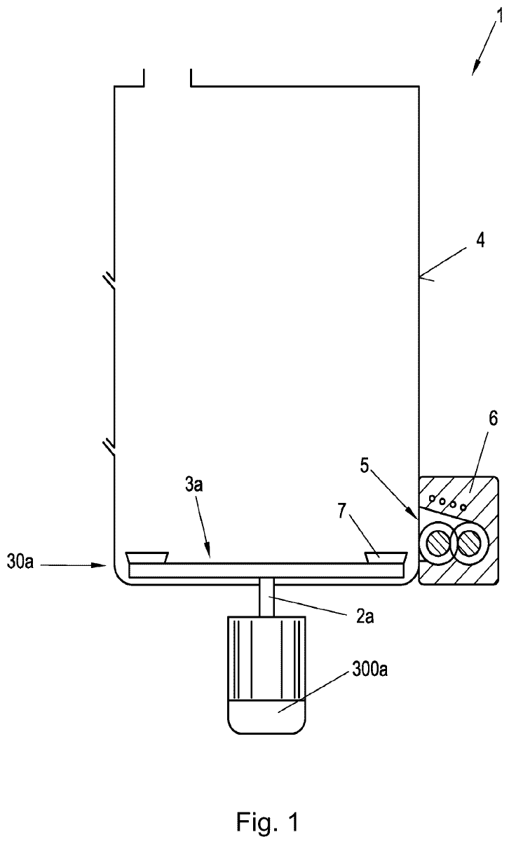

FIG. 1 shows a first embodiment of an inventive device.

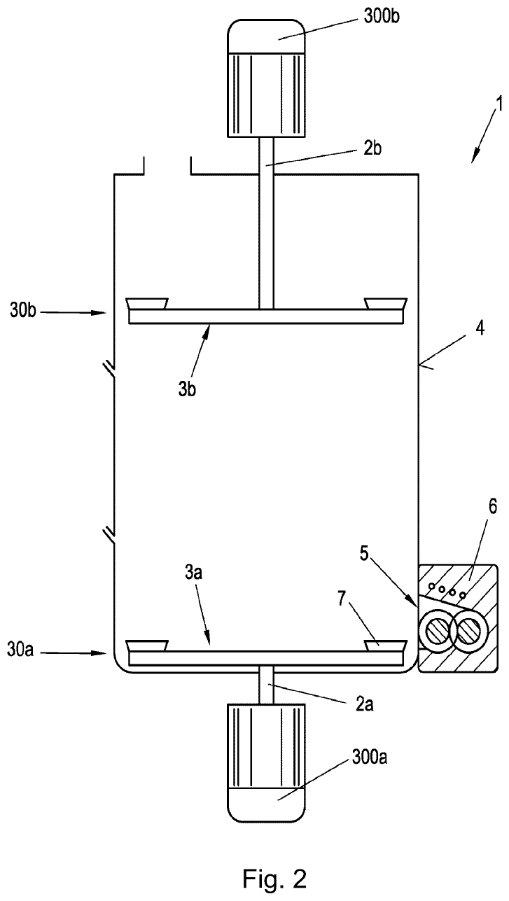

FIG. 2 shows a further embodiment of an inventive device.

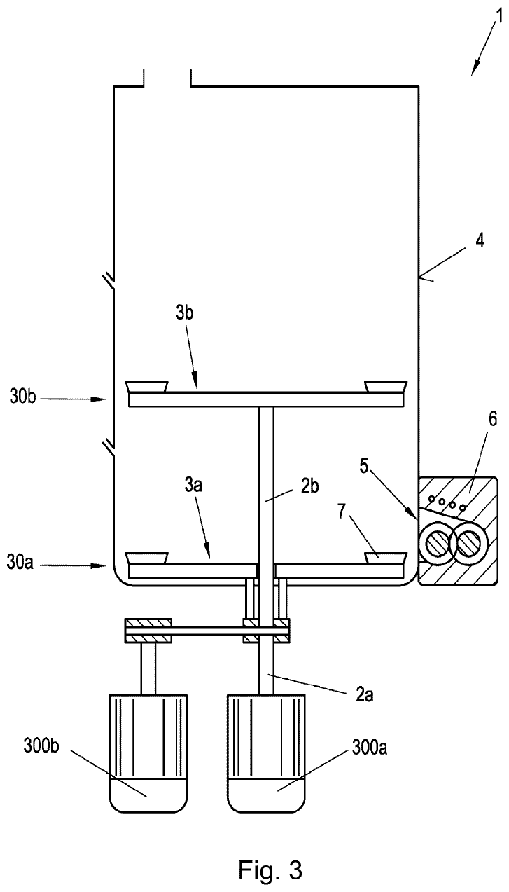

FIG. 3 shows yet another embodiment of an inventive device.

FIG. 4 shows the result of a comparison test not in accordance with the invention.

FIG. 5 shows the result of a comparison test.

FIG. 1 shows a first advantageous embodiment of an inventive device for processing or treating polymer materials, in particular thermoplastic waste plastic for recycling purposes. The basic structure and basic function of such a cutter-compactor—extruder combination is sufficiently known, for example from EP 2 558 263 or EP 2 689 908, and is only briefly described below.

Furthermore, it should be noted that the illustrations in FIGS. 1 through 3 are strictly schematic.

The device shown in FIG. 1 comprises a cylindrical container or cutter-compactor or a preconditioning unit (PCU) 1 for accommodating the polymer material to be processed. Such a container 1 is already sufficiently known from EP 123 771, for example. The container 1 is cylindrical with a flat bottom surface and a cylinder-shaped jacket side wall 4 aligned vertically thereto.

A rotatable or rotating tool 3a is arranged in the container 1. Here, the tool 3a is a flat carrier disc arranged at a small distance to the bottom surface, which tool rotates about an axis of rotation, is aligned parallel to the floor surface, and has knives 7 mounted on its upper side. The carrier disc is rotationally driven by a motor 300a by an axis 2a, wherein the motor 300a is arranged below the container 1. Here, the axis of rotation or axis 2a is arranged in the central longitudinal axis or center axis of the container 1.

The tool 3a—among other things—moves, mixes, heats, and comminutes the material present in the container 1. The thermoplastic materials are accordingly without limitation mixed, heated, softened, compacted, pre-degassed, dried, dehumidified, cut, comminuted, crystallized, and/or homogenized in the container 1, and their bulk density is increased. The rotation of the tool 3a forms a mixing vortex in the material and the material remains in the container 1 for a certain dwell time and is pretreated there accordingly.

A container opening 5 is formed in the side wall 4 of the container 1 at the height of the only tool 3a in the present case or at the height of the lower-most tool plane 30a. The housing or the infeed opening of a conveyor 6, here of a compacting twin-screw extruder 6, is connected tangentially to this container opening 5. Particularly on multi-screw extruders, the infeed is particularly sensitive and constant feeding at the most consistent level is particularly important.

The outer edges of the tool 3a reach relatively closely—about 5% of the radius—to the side wall 4. In the area of the container opening 5, the screw of the extruder 6 that is close the container is adapted to, and positioned back from, the contour of the inner wall 4 of the container 1. No part of the extruder 6 projects into the interior of the container 1. The tools 3a or the knives 7 are at approximately the same height or plane of the central longitudinal axis of the extruder 6.

During practical operation, the plastic material to be processed—usually in the form of plastic waste, bottles or films—is introduced into container 1. The introduced plastic material is comminuted, mixed, among other things, by the rotating tool 3a and is heated and softened, but not melted, by the introduced mechanical friction energy. After a certain dwell time in the container 1, the softened but not molten material is discharged from the container 1 through the container opening 5 and fed to the extruder 6, or the extruder 6 is fed in this manner.

In the present exemplary embodiment, the extruder 6 is a readily known, conventional synchronous twin-screw extruder, in which the softened plastic material is melted in a first zone, then compacted, and the polymer melt then exits or is granulated on the opposing side.

The invention specifies a measuring device (not shown here) for measuring the torque of the extruder 6 or the two extruder screws. Such torque measuring devices for extruders are known. The invention also specifies a measurement device (likewise not shown) with a communication link or data link to the measuring device for controlling the rotational speed of the tool 3a. This control device controls the rotational speed of the tool 3a as a function of the torque of the extruder 6 measured by the measuring device. The torque of the extruder 6 is measured here continuously at defined, suitably small time intervals and the data is transmitted to the control device in order to be able to react to changes and to adjust the rotational speed of the tool 3a, quickly and continuously.

In the present case, the rotational speed of the tool 3a is controlled such that the torque of the extruder 6 remains substantially constant and the fluctuations of the torque are less than +/−5%.

Due to the adjusted rotational speeds of the tool 3a, the packing cycles in the extruder 6 are directly influenced, and the torque of the extruder 6 in turn changes according to the fill level of the screw channels of the extruder 6. In this way, the fill level of the extruder 6 can be kept very constant (see also Example 1 below).

The device of FIG. 2 is adapted largely analogously to the device of FIG. 1, but has two tools 3a, 3b in the container 1 in two tool planes 30a, 30b one above the other, specifically two carrier disks with knives arranged parallel in relation to each other.

The lower tool 3a or the lower-most tool plane 30a is arranged in the area or at the height of the container opening 5 or the infeed opening of the twin-screw extruder 6. The upper tool 3b or the upper tool plane 30a is arranged in the center to upper region of the container 1.

The tools 3a, 3b in the two tool planes 30a, 30b can be rotated independently and at different rotational speeds by two separate drives 300a, 300b arranged below and above the container 1.

The rotational speed of the lower tool 3a in the lower-most tool plane 30a is controlled according to the invention as a function of the torque of the extruder 6.

In order to compensate for different parameters in the input material and to ensure good processing, it can be advantageous if the rotational speed of the other tool 3b arranged above these is adjustable independently of the torque of the extruder 6. These tools 3b can for example rotate at a rotational speed that is fixed, freely adjustable, or dependent on other parameters, and that is specifically not dependent on the torque of the conveyor or extruder or is not torque-controlled by the control device.

This is realized in the present exemplary embodiment according to FIG. 2 and the rotational speed of the upper tool 3b in the tool plane 30b above these is controlled or adjusted independently or not directly dependent on the torque of the extruder 6. Here, the temperature of the material is measured in the area of the upper tool plane 30b and the rotational speed of the upper tool 3b is controlled or changed as a function of this material temperature. However, this is only an exemplary option (see also example 2 below).

The device according to FIG. 3 is in turn a device analog to the device of FIG. 2. The only difference is that in FIG. 3 both tools 3a and 3b are driven from below, i.e. by motors or drives 300a, 300b, both of which are arranged below the container 1. The rotary or drive axes 2a and 2b are aligned concentrically in one another.

### Tests:

The following tests were each carried out on an exemplary inventive test system. This was a PCU (Preconditioning Unit)/twin-screw extruder combination, equipped with a melt filter SW 4/134 according to the system configuration shown below (PCU configuration 1 or 2).

Ground-up HD-PE bottle material was used as the test material. This material was obtained from used hygiene containers, e.g. shampoo bottles, or used cleaning agent containers, e.g. household cleaner. This material was first comminuted and then pre-cleaned in a washer. The basic properties or parameters of this material are that it can be readily gravity-fed but has different bulk densities and also has different moisture contents.

Each of the test setups had a measuring device for measuring the torque of the extruder and a control device connected to the measuring device for controlling the rotational speed of the tool. The control device was programmed, adapted and set up to control the rotational speed of the tool as a function of the torque of the conveyor or extruder.

### EXAMPLE 1

In PCU configuration 1 (comparable to a device according to FIG. 1), a preconditioning unit (PCU) or a container or a cutter-compactor was used, which had a tool with a drive variable in its rotational speed. A single (bottom) tool plane was constructed here, which was arranged in the area of the container opening or in the area of the extruder infeed. The rotational speed of this tool was therefore inventively controlled as a function of the extruder torque.

PCU configuration 1:

| PCU | | |
|---|---|---|
| configuration 1 | Device type | Comment |
| PCU | 1300 mm diameter | EREMA, a variable |
| (container) | | rotational speed drive |
| Extrusion unit | Twin screw, | Made in China |
| | synchronized 63 mm | |
| | screw diameter | |
| Melt filter | RTF 4/134 | EREMA, filtration 150 μm |
| Melt pump | SP 45 | Maag melt pump |
| gear wheel | | |
| Granulation | HG 152 Hot die-face | EREMA granulator |
| | cutter | |

Due to the rotational speeds of the tools adjusted in this manner, the fill level of the extruder could already be kept constant in this configuration 1. The infeed behavior of the extruder, the throughput and the throughput consistency were also improved and the quality of the obtained PE polymer materials was very high.

### EXAMPLE 2

In PCU configuration 2 (similar to a device according to FIG. 2 or FIG. 3), a PCU was used that had two variable rotational speed drives.

A first lower tool plane (infill plane) was located in the area of the extruder infeed and the rotational speed of the tools of these tool planes was influenced and controlled by the torque of the extruder. The rotational speed of this tool was therefore inventively controlled as a function of the extruder torque.

A second tool plane above these was arranged above the first tool plane or filling plane. This was carried out with a second drive with variable rotational speed. This second tool plane (which can also consist of a plurality of tool planes arranged above one another) was responsible for the advantageous treatment of the incoming material. The rotational speed of the tools of this tool plane was controlled such that the energy input into the material was controlled to reach a certain material temperature. The material temperature was measured using measuring systems that project into the material or contactlessly sense the temperature from the side or top. This temperature was substantially determined of the introduced polymer. The object was to ensure that the incoming material chips reach a certain temperature that is close to the softening temperature of the polymer. This ensured that a certain pre-compaction is generated, i.e. the bulk density is homogenized, and furthermore that the melting process in the extruder is facilitated because the full mass of the material is brought to a temperature close to the softening point. Since the softening temperatures of the thermoplastic polymers used here are in the range at which water evaporates, the residual moisture of the incoming material was also removed.

PCU configuration 2:

| PCU | | |
|---|---|---|
| configuration 2 | Device type | Comment |
| PCU | 1300 mm diameter | EREMA, two variable |
| | | rotational speed drives |
| Extrusion unit | Twin screw, | Made in China |
| | synchronous, 63 mm | |
| | screw diameter | |
| Melt filter | RTF 4/134 | EREMA, filtration 150 μm |
| Melt pump | SP 45 | Maag melt pump |
| gear wheel | | |
| Granulation | HG 152 Hot die-face | EREMA granulator |
| | cutter | |

The result is shown in FIG. 5, and the torque of the extruder is shown as a function of the tool rotational speed.

In FIG. 5, the torque change of the extruder can be seen as a function of the rotational speed of the tools in the lower-most tool plane of the PCU. In this experiment, the rotational speed of the tools of the lower-most tool plane of the PCU was thus varied as a function of the extruder torque. In doing so, one did not have to deal directly with the needs of the incoming material, e.g., humidity, compression and material temperature in the PCU, as this was done by the upper tool plane with its own drive.

The advantageously uniform torque of the extruder, which exhibits little or no fluctuations, is clearly discernible in FIG. 5. In this manner, the fill level of the extruder could be kept extremely constant and also sufficiently high. The infeed behavior of the twin-screw extruder, the throughput and the throughput consistency were improved. The quality of the HD-PE granules obtained in this way was very satisfactory.

1. Method for processing or treating polymer materials, in particular thermoplastic waste plastic for recycling purposes, wherein the polymer materials to be processed in a container or cutter-compactor (1) are processed by at least one rotatable or rotating tool (3a, 3b), optionally, a plurality of rotatable or rotating tools (3a, 3b), moved, mixed, heated and, optionally, comminuted, and wherein the polymer materials, which are in the form of pieces or particles, are subsequently discharged from the container (1) and introduced into a conveyor (6), in particular an extruder (6), preferably a twin-screw or multi-screw extruder, are introduced, in particular in order to be compacted and melted or agglomerated therein, characterized in that the torque of the conveyor (6) is measured and the rotational speed of the tool or at least one of the tools (3a, 3b) is controlled or changed as a function of the torque of the conveyor (6).

2. Method according to claim 1, characterized in that the torque of the conveyor (6) is continuously measured at defined, in particular regular, intervals.

3. Method according to any of claims 1 through 2, characterized in that the conveyor (6) is operated at a fixed rotational speed.

4. Method according to any of claims 1 through 3, characterized in that the rotational speed of the tool (3a, 3b) is reduced as the torque of the conveyor (6) increases and/or in that the rotational speed of the tool (3a, 3b) is increased as the torque of the conveyor (6) decreases.

5. Method according to any of claims 1 through 4, characterized in that the rotational speed of the tool (3a, 3b) is controlled such that the torque of the conveyor (6) remains constant or the fluctuations of the torque are less than +/−5%.

6. Method according to any of claims 1 through 5, characterized in that the rotational speed of the tool (3a, 3b) is controlled such that the fill level of the conveyor (6) remains constant or the fluctuations of the fill level are low/less than +/−10%.

7. Method according to any of claims 1 through 6, characterized in that the rotational speed of the tool (3a, 3b) is controlled such that the rotational speed of the tool (3a, 3b) does not fall below a certain minimum rotational speed.

8. Method according to any of claims 1 through 7, characterized in that the rotational speed of the tool (3a, 3b) can additionally also be adjusted, in particular increased, independently of the torque of the conveyor (6).

9. Method according to any of claims 1 through 8, characterized in that the tools (3a, 3b) are arranged in the container in at least two tool planes (30a, 30b) arranged one above the other.

10. Method according to any of claims 1 through 9, characterized in that the tool (3a) or the lower-most tool plane (30a) is arranged in the area or at the height of the infeed opening of the conveyor (6) or the container opening (5).

11. Method according to any of claims 9 through 10, characterized in that the tools (3a, 3b) in the individual tool planes (30a, 30b) can be rotated independently of each other and at different rotational speeds, in particular by separate drives (300a, 300b).

12. Method according to any of claims 9 through 11, characterized in that the rotational speed of the tool (3a) in the lower-most tool plane (30a) is controlled as a function of the torque of the conveyor (6).

13. Method according to any of claims 9 through 12, characterized in that the rotational speed of the tool (3a) in the lower-most tool plane (30a) is controlled as a function of the torque of the conveyor (6) and in that the rotational speed of the tool or tools (3b) in the other tool plane(s) (30b) above these is controlled or adjusted independently of the torque of the conveyor (6).

14. Method according to any of claims 9 through 13, characterized in that the rotational speeds of all tools (3a, 3b) in each tool plane (30a, 30b) are controlled independently and separately from one another as a function of the torque of the conveyor (6).

15. Method according to any of claims 9 through 14, characterized in that the rotational speed of the tool(s) (3b) in the other tool plane(s) (30b) above these is controlled such that a certain material temperature is reached in this area and/or in that the temperature of the material is measured in this area and the rotational speed of the tool(s) (3b) in the other tool plane(s) (30b) above these is controlled or changed as a function of this material temperature.

16. Device for processing or treating polymer materials, in particular thermoplastic waste plastic for recycling purposes, in particular for carrying out the method according to claim 1, having at least one container or cutter-compactor (1) for the material to be processed, at least one tool (3a, 3b) which can be rotated or rotates about an axis of rotation (2), optionally a plurality of rotatable or rotating tools (3a, 3b), being arranged in the container (1) for moving, mixing, heating and optionally comminuting the material. wherein a container opening (5) is formed in the container (1), in particular in a side wall (4) of the container (1), in particular in the region of or at the height of the lowermost or bottom-nearest tool (3a), through which the pretreated material can be discharged from the interior of the container (1), wherein at least one conveyor (6), in particular extruder (6), is provided for receiving the material discharged from the container (1), characterized in that a measuring device for measuring the torque of the conveyor (6) is provided, in that a control device is provided, which control device has a communication link to the measuring device for controlling the rotational speed of the tool (3a, 3b) or at least one of the tools (3a, 3b), wherein the control device is adapted or equipped to control the rotational speed of the tool (3a, 3b) as a function of the torque of the conveyor (6).

17. Device according to claim 16, characterized in that the measuring device is adapted to continuously measure the torque of the conveyor (6) at defined, in particular regular, intervals.

18. Device according to any of claims 16 through 17, characterized in that the control device is adapted to operate the conveyor (6) at a fixed rotational speed.

19. Device according to any of claims 16 through 18, characterized in that the control device is adapted to reduce the rotational speed of the tool (3a, 3b) as the torque of the conveyor (6) increases and/or to increase the rotational speed of the tool (3a, 3b) as the torque of the conveyor (6) decreases.

20. Device according to any of claims 16 through 19, characterized in that the control device is adapted to adjust the rotational speed of the tool (3a, 3b) such that the torque of the conveyor (6) remains constant or is half-bar or the fluctuations of the torque are less than +/−5%.

21. Device according to any of claims 16 through 20, characterized in that the control device is adapted to adjust the rotational speed of the tool (3a, 3b) such that the fill level of the conveyor (6) remains constant or is half-bar or the fluctuations of the fill level are low/less than +/−10%.

22. Device according to any of claims 16 through 21, characterized in that the control device is adapted to adjust the rotational speed of the tool (3a, 3b) such that the rotational speed of the tool (3a, 3b) does not fall below a certain minimum rotational speed.

23. Device according to any of claims 16 through 22, characterized in that the rotational speed of the tool (3a, 3b) can additionally also be adjusted, in particular increased, independently of the torque of the conveyor (6).

24. Device according to any of claims 16 through 23, characterized in that in the container (1) a plurality of, at least two, tools (3a, 3b) are arranged in different tool planes (30a, 30b) or at different distances to the bottom surface or lower-most region of the container (1), and in that the tools (3a, 3b) are arranged in the container (1) in at least two tool planes (30a, 30b) arranged one above the other.

25. Device according to any of claims 16 through 24, characterized in that the tool (3a) or the lower-most tool (3a) or the lower-most tool plane (30a) is arranged in the area or at the height of the container opening (5) or the feed opening of the conveyor (6) connected to the container opening (5).

26. Device according to any of claims 24 through 25, characterized in that the tools (3a, 3b) in the individual tool planes (30a, 30b) can be rotated independently of each other and at different rotational speeds, in particular by separate drives (300a, 300b).

27. Device according to any of claims 24 through 26, characterized in that the rotational speed of the tool (3a) in the lower-most tool plane (30a) can be controlled by the control device as a function of the torque of the conveyor (6).

28. Device according to any of claims 24 through 27, characterized in that the rotational speed of the tool (3a) in the lower-most tool plane (30a) can be controlled by the control device as a function of the torque of the conveyor (6) and in that the rotational speed of the tool or tools (3b) in the other tool plane(s) (30b) above these is controlled or adjustable independently of the torque of the conveyor (6).

29. Device according to any of claims 24 through 28, characterized in that the rotational speeds of all tools (3a, 3b) in each tool plane (30a, 30b) can be controlled by the control device, in each case as a function of the torque of the conveyor (6), independently and separately from one another.

30. Device according to any of claims 24 through 29, characterized in that the rotational speed of the tool or tools (3b) in the other tool plane(s) (30b) above these is controlled such that a certain material temperature is reached in this area and/or in that the rotational speed of the tool or tools (3b) in the other tool plane(s) (30b) above these can be controlled or changed as a function of this material temperature.

31. Device according to any of claims 16 through 30, characterized in that the conveyor (6) is an extruder (6) with at least two screws, in particular a twin screw extruder.
